(19) United States
(12) Patent Application Publication
(10) Pub. No.: US 2012/0144367 A1
(43) Pub. Date: Jun. 7, 2012

(54) EVENTS FIRED PRE- AND POST-METHOD EXECUTION

(75) Inventors: Peter Villadsen, Sammamish, WA (US); Karl Simonsen, Redmond, WA (US); Marcos Calderon Macias, Seattle, WA (US); Ramakanthachary Gottumukkala, Sammamish, WA (US)

(73) Assignee: Microsoft Corporation, Redmond, WA (US)

(21) Appl. No.: 12/960,710

(22) Filed: Dec. 6, 2010

(51) Int. Cl. G06F 9/44

(52) U.S. Cl. 717/120

(57) ABSTRACT

Customization of source code of a software program like a business application is enabled without modifying the source code of the software. External pieces of source code may be executed prior to, and/or following the invocation of selected methods. The external methods executed prior to a designated method call may change the parameter values that the designated method gets called with, and the methods executed after the designated method has been called may change a value returned from the designated method.

### BACKGROUND

With the proliferation of computing devices, software has become an integral part of daily work and personal lives. Business applications are a major segment of software that enable users to perform business related tasks such as accounting, customer relationship management, inventory, sales, marketing, and many more. Increasingly, integrated and modular business applications are becoming popular. Locally installed or hosted business applications provide services related to a variety of business aspects. Since businesses (for that matter, non-commercial organizations as well) vary in size and type, their needs are typically served by special purpose business applications or customized versions of general purpose business applications.

Designing a software program such as a business application is a complex undertaking that typically involves in-depth research, large amounts of code, extensive testing, etc. When it comes to customization of complex software like a business application, designers may either provide a limited number of default alternatives, which may restrict user experience, or provide access to the entire code for developers of custom code. When a large portion or the entire code of a software application is accessible, however, the original developers lose control over characteristics of the program. Changes made by various developers may invalidate any testing performed on the original program, unexpected faults or execution results may occur over which the original developers have no control. Thus, opening the code may have unintended results that defeat the purpose of the program (i.e. user satisfaction).

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling customization of source code of a software program like a business application without modifying the source code of the software. According to some embodiments, external pieces of source code may be executed prior to, and/or following the invocation of selected methods. The external methods executed prior to a designated method call may change the parameter values that the designated method gets called with, and the methods executed after the designated method has been called may change a value returned from the designated method.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating example methods and handlers in a software environment;

FIG. 2 illustrates an example pre- and post-activation diagram;

FIG. 3 illustrates another example pre- and post-activation diagram;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of using pre- and post-handlers to customize a software program according to embodiments.

### DETAILED DESCRIPTION

As briefly described above, software applications may be customized without modifying the source code by inserting pre- and post-method handlers. Pre-handlers may modify parameters passed on to a selected method, while post-handlers may modify return values from selected methods. In some implementations, the post-handlers may modify the parameters to subsequent post-handlers too. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable storage media.

Throughout this specification, the term “platform” may be a combination of software and hardware components for executing applications, where embodiments may be implemented. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. While business applications are used as examples of software for implementing pre- and post-handlers in customizing programs without modifying source code, embodiments may be implemented in any type of application. More detail on these technologies and example operations is provided below.

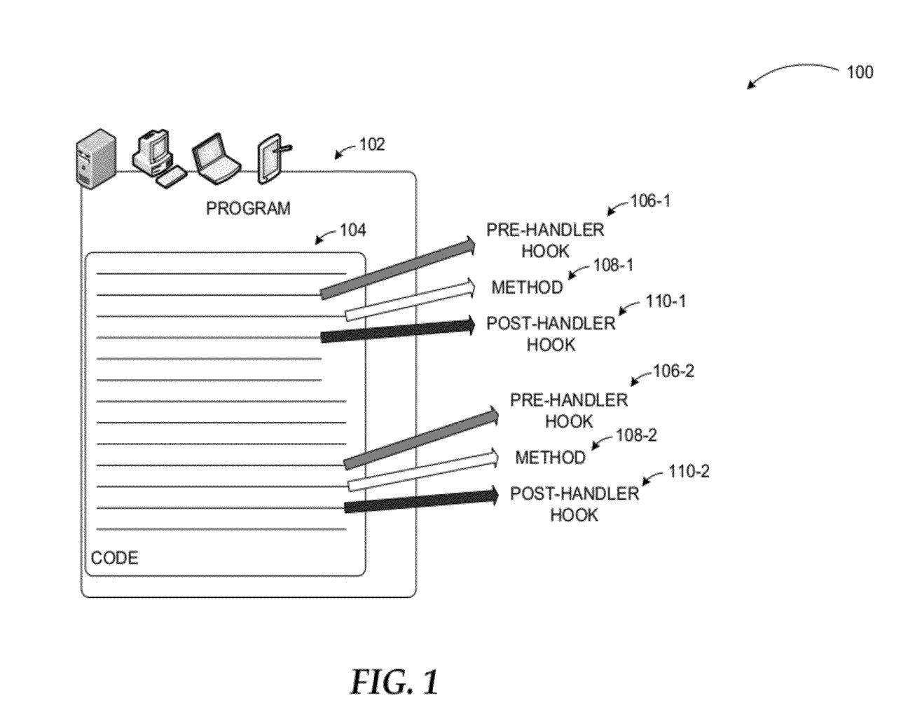

FIG. 1 includes conceptual diagram 100 illustrating example methods and handlers in a software environment. In its basic form, a source code may include statements, declarations, methods, operators, and keywords. A method is a subroutine that is associated either with a class, in which case it is called a class method or a static method, or with an object, in which case it is an instance method. A method usually comprises a sequence of programming statements to perform an action, a set of input parameters to customize those actions, and possibly one or more output values (also called the return value(s)). Methods provide a mechanism for accessing and processing specified portions of data.

Basically, a method or a subroutine performs a self-contained computation on a portion of data based on provided input parameters outputting one or more return values. A source code may include anywhere from a few to thousands of methods. A typical business application may be at the higher range of complexity with a large number of methods. Since the methods interact with each other (i.e., one method's return value(s) may be used as input parameter for one or more other methods), consistency and defined limits for operations are significant design parameters in software development. Thus, developers define certain limits to their program at design stage as to what the program can do, which inputs it can take, which outputs it can provide, how the user interfaces are controlled, and so on.

In today's world of variety in every aspect such as business operations, types, needs, etc., the limits on generic software design are counter-productive for consumers of the programs. On the other hand, testing, verification, maintenance, upgrades, etc. of the software programs inherently require those limits. Thus, a flourishing new industry of software customization takes advantage of this dichotomy providing custom solutions to wide variety of consumers based on available generic solutions. As discussed above, enabling customizers to have access to the entire source code brings software developers back to square one, because there may be many custom versions of the same software, and consumers may believe the original developers are ultimately responsible.

A software customization system according to embodiments enables customization of complex software without modification of the source code, while enabling customizers to modify many aspects of the program by customizing an input and an output of each method in the program. This may be accomplished by providing “hooks” or insertion points for pre-handlers (106-1, 106-2) and/or post-handlers (110-1, 110-2) before and after each method (108-1, 108-2) in the source code 104 of a software program 102, which may be executed by a server, a desktop computer, a laptop computer, a handheld computer, a vehicle-mount computer, a smart phone, and comparable computing devices.

Pre- and post-handlers are essentially external methods that may be defined by a customizing developer or selected among a plurality of optional methods provided by the original developer. A pre-handler may take the input parameters of the method it is associated with and provide its potentially modified parameter value(s) as input parameter to the method, thereby potentially modifying the input of the method. A post-handler may take the return value of the method it is associated with as input parameter(s). Thus, the post-handler may modify the output of the method. Thereby, input and/or output of one or more methods in the source code may be modified without the source code itself being modified.

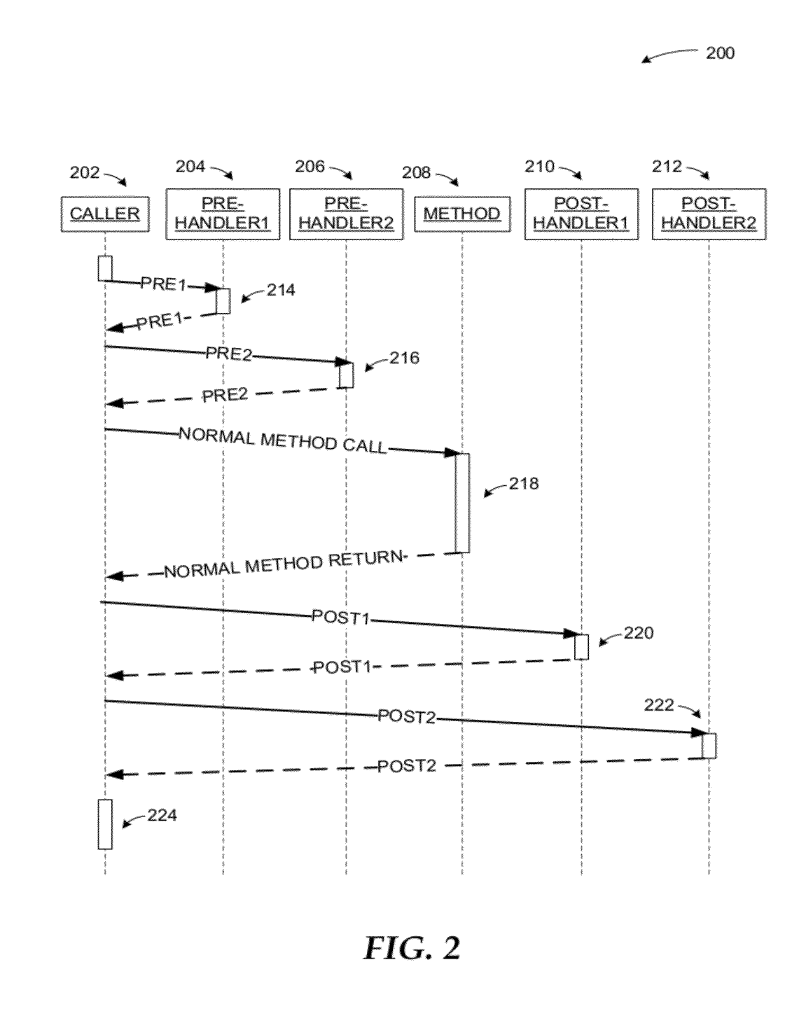

FIG. 2 illustrates example pre- and post-activation diagram 200. As shown in diagram 200, in regular execution of a source code, a process (caller 202) may call a method 208 passing input parameters to it and receiving return values as a result of the execution of method 208. To customize the relationship between the input parameters and the return values, method 208 would have to be modified meaning the source code itself would need to be modified. In a general purpose business application, where a large number of specific scenarios may result in a need for as many customizations, this may mean a large number of custom versions of the program. Considering how many methods are commonly included in a typical software program, the number of customizations that may require testing, verification, and maintenance may exponentially grow and the cost of ownership increases with it.

In a system according to embodiments, one or more pre-handlers (204, 206) and post-handlers (210, 212) may be employed to customize the source code without actually modifying the method 208. Pre- and post-handlers may be used with selected methods and they may be used in any configuration (i.e., none, one, or multiple pre-handlers and/or post-handlers may be associated with the selected methods). In the example scenario, two pre-handlers and two post-handlers are associated with method 208. When method 208 is called, first pre-handler 204 is called (214) with the parameters sent to method 208. Pre-handler 204 may calculate new values for the parameters and pass them on to pre-handler 206, which may calculate yet other values based on the received input (216). The value(s) calculated by the second pre-handler 206 based on the parameters (as calculated by the first pre-handler 204) may be passed on to method 208 and the method executed as it would normally be executed (218). An order of the pre- and/or post-handlers may be predefined according to program definitions or defined by the customizing developer. In yet other embodiments, the order in which the pre- and/or post-handlers are called may be undefined.

According to other embodiments, return values of method 208 may also be modified in addition to the input parameters for the method. Return value(s) of method 208 may be passed on to the first post-handler 210 and that post-handler executed (220). In case of multiple post-handlers, the return value(s) of the preceding post-handlers may be passed on to subsequent post-handlers (e.g., 222) until the final post-handler is executed and its return value(s) propagated in the program (224).

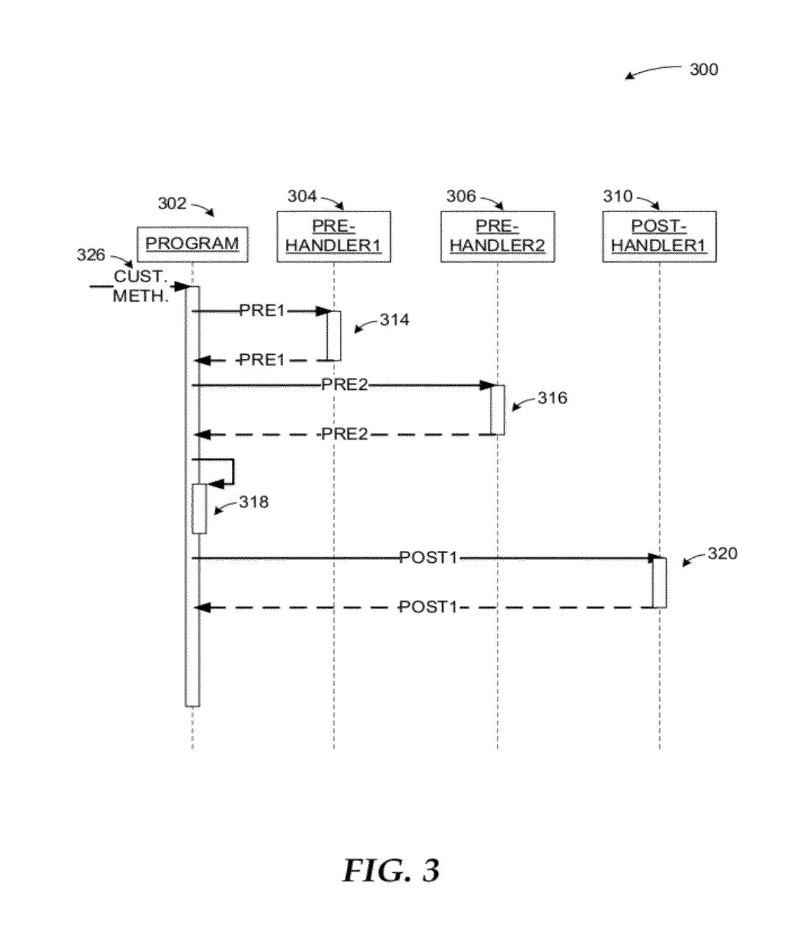

FIG. 3 illustrates another example pre- and post-activation diagram 300. Diagram 300 illustrates another example scenario, where a customizable method 326 is called within program 302. According to the example scenario, there are two pre-handlers and one post-handler associated with the customizable method 326. Thus, any number of pre- and/or post-handlers may be used in conjunction with a method in a program. Pre-handler 304 may be called first (314) with the parameters for the customizable method. Value(s) calculate by pre-handler 304 may be provided to pre-handler 306, which is executed (316) and its computed value(s) passed on to the customizable method 326 itself. The customizable method 326 is executed with the parameters received from second pre-handler (318) and the return value(s) of the method are provided to the only post-handler 310 in this example implementation. Upon execution of the post-handler 310 (320), the return value(s) of this custom method are returned to the program.

A pre- and post-handler based mechanism according to embodiments provides events as a way of decoupling source code and optional customization code in higher layers. Rather than having to replicate and then maintain all the system layer code, this mechanism in many cases enables developers to simply register event handlers to add customized behavior to existing methods.

The pre- and post-method feature also allows developers to register static event handlers (methods) for existing class and table methods, which may be called either at the beginning or at the end of normal method execution. Pre-handlers may have access to and can potentially modify input arguments to the method and similarly post-handlers may have access to and can potentially modify the return value from the method. If multiple event handlers are registered for a given method, their execution may be according to a predefined or undefined order.

The configurations and implementations of pre- and post-handler based customization discussed above are for illustration purposes and do not constitute a limitation on embodiments. Embodiments may be implemented employing other modules, processes, and configurations using the principles discussed herein.

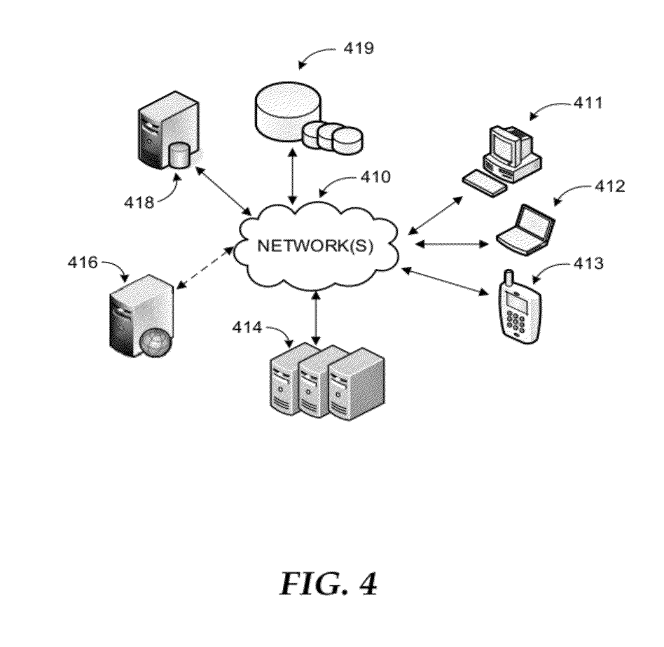

FIG. 4 is an example networked environment, where embodiments may be implemented. Pre- and post-handler based source code customization may be implemented via software executed over one or more servers 414 or a single server (e.g. web server) 416 such as a hosted service. The platform may communicate with client applications on individual computing devices such as a smart phone 413, a laptop computer 412, or desktop computer 411 (‘client devices’) through network(s) 410.

As discussed above, insertion points (“hooks”) may be placed in the source code an application such that pre- and post-handlers can be implemented. When a method is called, the called method may call any pre-handlers for the designated method in a predefined order. The parameters may be passed to each of these pre-handlers, and each handler may modify the parameters that are passed to the next handler, and ultimately to the designated method. When the designated method has ended its execution, it will determine whether or not any post-handlers are specified for the designated method. If so, these handlers will be called in a predefined defined order. The value returned may then be modified by each of the post-handlers.

In a networked environment, client devices 411-413 may enable access to applications executed on remote server(s) (e.g. one of servers 414) as discussed previously. The server(s) may retrieve or store relevant data from/to data store(s) 419 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to implement source code customization through pre- and post-handlers. Furthermore, the networked environments discussed in FIG. 4 are for illustration purposes only. Embodiments are not limited to the example applications, modules, or processes.

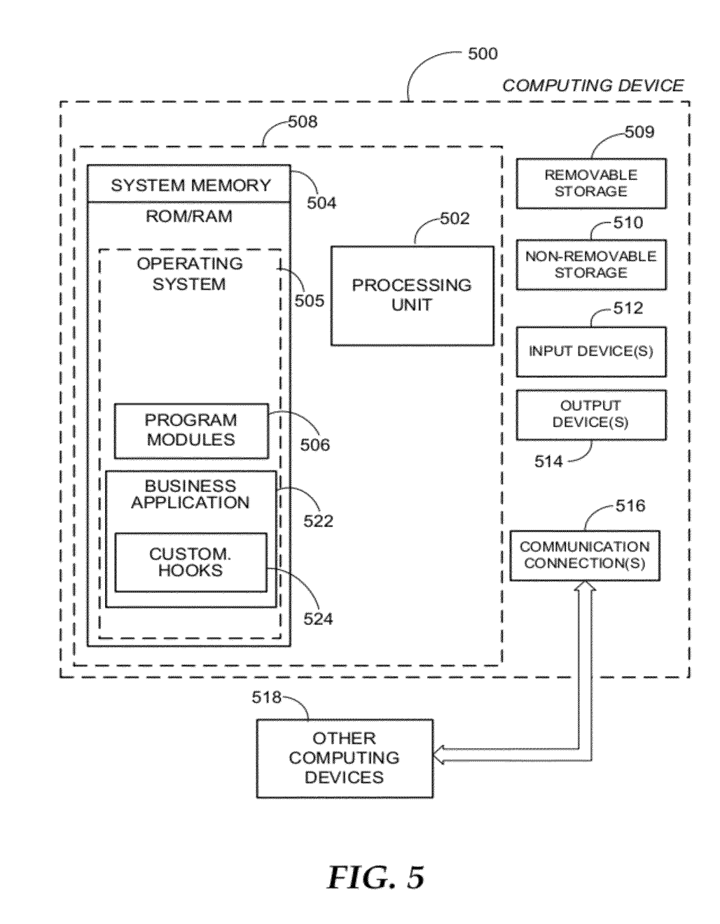

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any computing device executing a software application and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as program modules 506, business application 522, which may include customization hooks 524 in its source code.

Business application 522 may include pre- and post-handlers prior to and following methods such that parameters for selected methods and return values from those methods can be modified, thereby customizing the source code without actually modifying the source code itself. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, storage servers, and comparable devices. Communication connection(s) 516 is one example of communication media. Communication media can include therein computer readable instructions, data structures, program modules, and includes any information delivery media. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

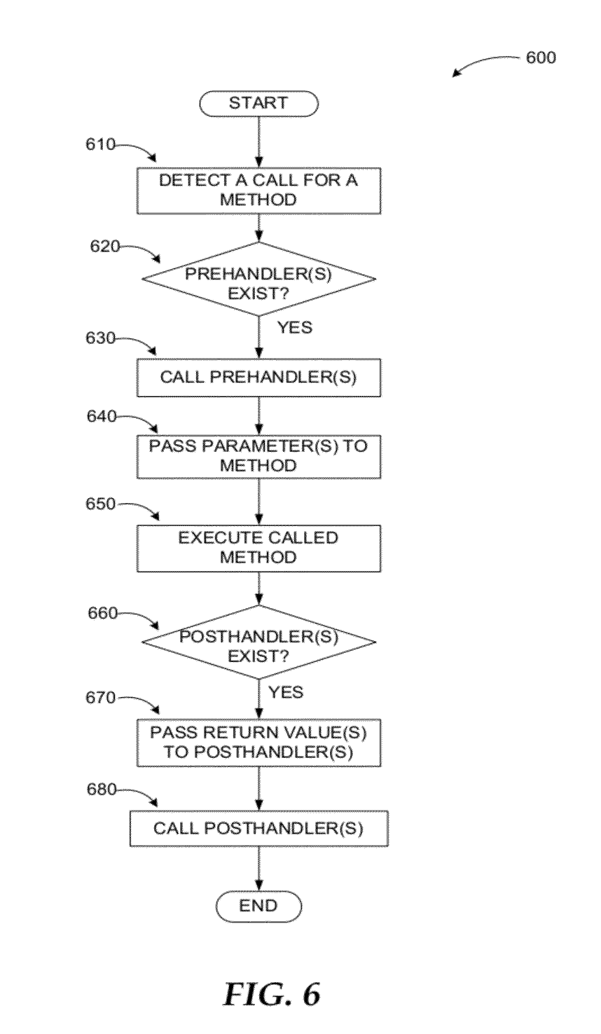

FIG. 6 illustrates a logic flow diagram for process 600 of using pre- and post-handlers in customizing source code according to embodiments. Process 600 may be implemented in any software application.

Process 600 begins with operation 610, where a call for a selected method within the source code is detected. The called method may determine at decision operation 620 whether any pre-handlers exist. According to some embodiments, optional or user supplied pieces of source code to be run (“triggered”) immediately prior to and/or immediately after the invocation of a particular method may be executed as pre- and post-handlers modifying parameters and return values of the method they straddle. If pre-handlers exist, they may be called at operation 630 and their results passed as parameters to the selected method at operation 640.

At operation 650, the selected method is executed. Following the execution of the selected method, another determination may be made whether any post-handlers exist at decision operation 660. If post-handlers exist, the return values of the executed method may be passed to those at operation 670 (if more than one post-handler exists, they may be executed serially). At operation 680, the post-handlers are called modifying the return values of the executed method, and thereby customizing the source code without modifying it.

The operations included in process 600 are for illustration purposes. Source code customization through pre- and post-handlers according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part by a computing device for source code customization, the method comprising:
in response to a method being called during execution of a program, determining if a pre-handler method exists;
if the pre-handler method exists, executing the pre-handler method with an input parameter of the method;
executing the method with a value computed by the pre-handler method as input parameter;
if a post-handler method exists, executing the post-handler method with a return value of the method as input parameter; and
propagating a return value of the post-handler method in the program, wherein the pre-handler and the post-handler methods are used to customize a behavior of the method without modifying a source code of the method.

2. The method of claim 1, further comprising:
if more than one pre-handler method exists, providing a return value of a pre-handler method as input parameter to a subsequent pre-handler method, wherein a first pre-handler method accepts the input parameter of the method as input parameter, and a value computed by a last pre-handler method is provided to the method as input parameter.

3. The method of claim 2, wherein an order of the pre-handler methods is defined by a constraint of the program.

4. The method of claim 1, further comprising:
if more than one post-handler method exists, providing a return value of the method to a post-handler method as input parameter and a return value of the post-handler method as input parameter to a subsequent post-handler method, wherein a return value of a last post-handler method is propagated in the program.

5. The method of claim 4, wherein an order of the post-handler methods is defined by a constraint of the program.

6. The method of claim 1, wherein the pre-handler and the post-handler methods are defined by a customizing developer.

7. The method of claim 1, wherein the pre-handler and the post-handler methods are selected by a customizing developer among a plurality of optional customization methods.

8. The method of claim 1, further comprising:
enabling a customizing developer to register the pre-handler and the post-handler methods.

9. The method of claim 1, wherein the pre-handler and the post-handler methods are static event handlers.

10. The method of claim 9, wherein the static event handlers are for existing class and table methods in the program.

11. A computing device for executing a customizable software program, the computing device comprising:
a memory storing instructions;
a processor coupled to the memory, the processor executing the customizable software program in conjunction with the instructions stored in the memory, wherein the processor is configured to:
enable a customizing developer to register at least one of a pre-handler method and a post-handler method;
in response to a method being called during execution of a program, determine if at least one of a pre-handler method and a post-handler method associated with the called method are registered;
if a pre-handler method associated with the called method is registered, execute the pre-handler method prior to executing the method;
execute the method with a value computed by the pre-handler method as input parameter for the method;
if a post-handler method associated with the called method is registered, execute the post-handler method with a return value of the method as input parameter for the post-handler method; and
propagate a return value of the post-handler method in the program, wherein the pre-handler and the post-handler methods are used to customize a behavior of the method without modifying a source code of the method.

12. The computing device of claim 11, wherein the processor is further configured to:
if more than one pre-handler methods are registered for the called method, provide the input parameter of the called method to a first pre-handler method, execute each pre-handler method using a value computed by a preceding pre-handler method as input parameter to a subsequent pre-handler method, and provide a value computed by a last pre-handler method to the called method as input parameter.

13. The computing device of claim 11, wherein the processor is further configured to:
if more than one post-handler methods are registered for the called method, provide the return value of the called method to a first post-handler method as input parameter, execute each post-handler method using a return value of a preceding post-handler method as input parameter to a subsequent post-handler method, and propagate a return value of a last post-handler method in the program.

14. The computing device of claim 11, wherein the processor is further configured to:
enable the customizing developer to add a property to program tables specifying which pre-handler methods and which post-event handler methods are to be ignored.

15. The computing device of claim 14, wherein the specified pre-handler methods and the post-handler methods are to be ignored on at least one from a set of predefined insert, update, and delete methods.

16. The computing device of claim 11, comprising one of a server, a desktop computer, a laptop computer, a handheld computer, a vehicle-mount computer, and a smart phone.

17. A computer-readable storage medium with instructions stored thereon for customizing a software program without modifying its source code, the instructions comprising:
enabling a customizing developer to register at least one of a pre-handler method and a post-handler method;
providing at least one of an insertion point prior to and another insertion point following a method with the program source code;
if a pre-handler method is inserted prior to a called method, executing the pre-handler method prior to executing the method;
executing the method with a value computed by the pre-handler method as input parameter for the method;
if a post-handler method is inserted following the called method, executing the post-handler method with a return value of the called method as input parameter for the post-handler method; and
propagating a return value of the post-handler method in the program, wherein the pre-handler and the post-handler methods are used to customize a behavior of the method without modifying a source code of the method.

18. The computer-readable storage medium of claim 17, wherein the instructions further comprise:
passing the value computed by the pre-handler method to the called method as input parameter; and
passing the return value of the called method to the post-handler method as input parameter.

19. The computer-readable storage medium of claim 18, wherein the instructions further comprise:
enabling serial execution of a plurality of pre-handler methods prior to the execution of the called method and serial execution of a plurality of post-handler methods following the execution of the called method, wherein return values of each pre-handler method and post-handler method are provided to respective subsequent pre-handler and post-handler methods as input parameters.

20. The computer-readable storage medium of claim 19, wherein the pre-handler methods, the post-handler methods, and an order of the pre-handler and the post-handler methods are defined by the customizing developer based on at least one constraint of the program.
